(19) United States
(12) Patent Application Publication
(10) Pub. No.: US 2020/0139996 A1
(43) Pub. Date: May 7, 2020

(54) Wheelbarrow Debris Bag Assembly

(71) Applicant: Sunil Jadonath, Winter Garden, FL (US)

(72) Inventor: Sunil Jadonath, Winter Garden, FL (US)

(21) Appl. No.: 16/178,667

(22) Filed: Nov. 2, 2018

(51) Int. Cl. B62B 1/20; B65F 1/00

(52) U.S. Cl. CPC B62B 1/204; B65F 1/002

(57) ABSTRACT

A wheelbarrow debris bag assembly for collecting and subsequently disposing of debris includes a wheelbarrow that has a bucket. A bag is positionable in the bucket of the wheelbarrow and debris is positioned in the bag when the bag is positioned in the bucket. Additionally, the bag has dimensions corresponding to dimensions of the bucket thereby facilitating the bag to conform to the bucket. A drawstring is slidably coupled to the bag for selectively closing the bag.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to debris bag devices and more particularly pertains to a new debris bag device for collecting and subsequently disposing of debris.

### BRIEF SUMMARY OF THE INVENTION

An embodiment of the disclosure meets the needs presented above by generally comprising a wheelbarrow that has a bucket. A bag is positionable in the bucket of the wheelbarrow and debris is positioned in the bag when the bag is positioned in the bucket. Additionally, the bag has dimensions corresponding to dimensions of the bucket thereby facilitating the bag to conform to the bucket. A drawstring is slidably coupled to the bag for selectively closing the bag.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a wheelbarrow debris bag assembly according to an embodiment of the disclosure.

FIG. 2 is an exploded perspective view of an embodiment of the disclosure.

FIG. 3 is a top view of an embodiment of the disclosure.

FIG. 4 is a left side view of an embodiment of the disclosure.

FIG. 5 is a cross sectional view taken along line 5-5 of FIG. 2 of an embodiment of the disclosure.

### DETAILED DESCRIPTION OF THE INVENTION

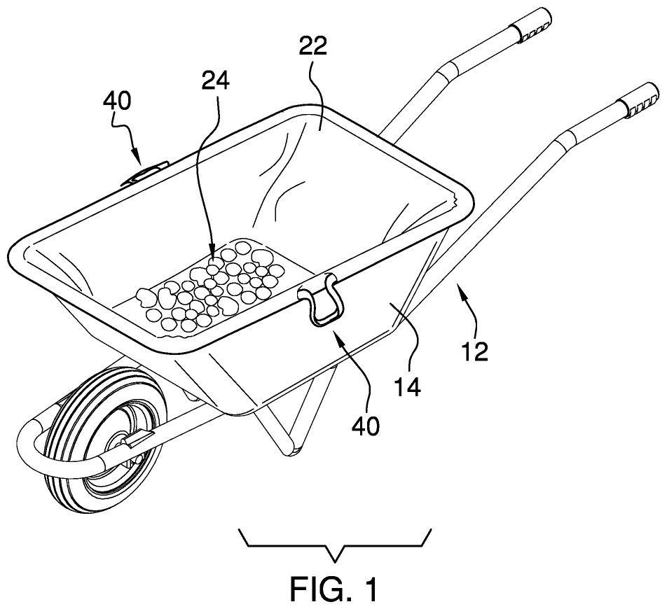

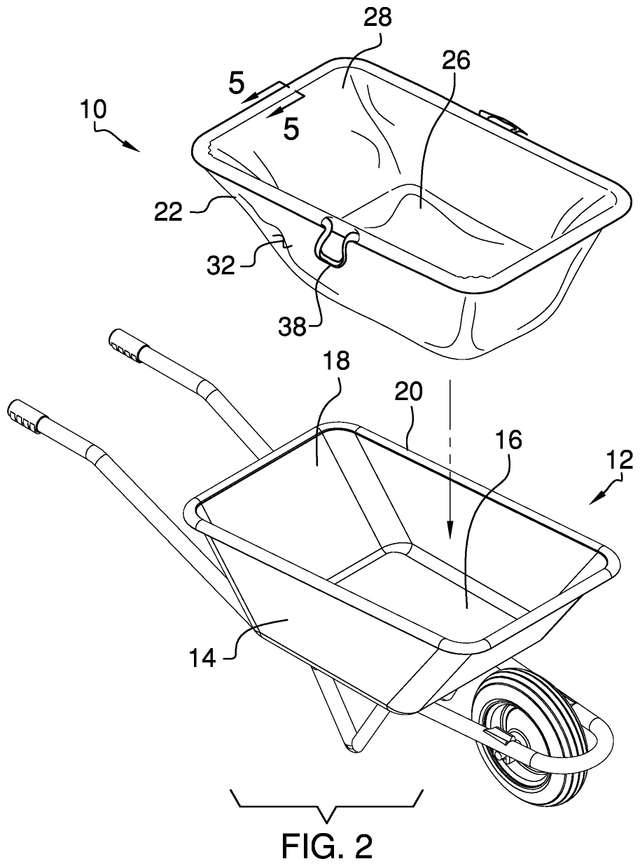

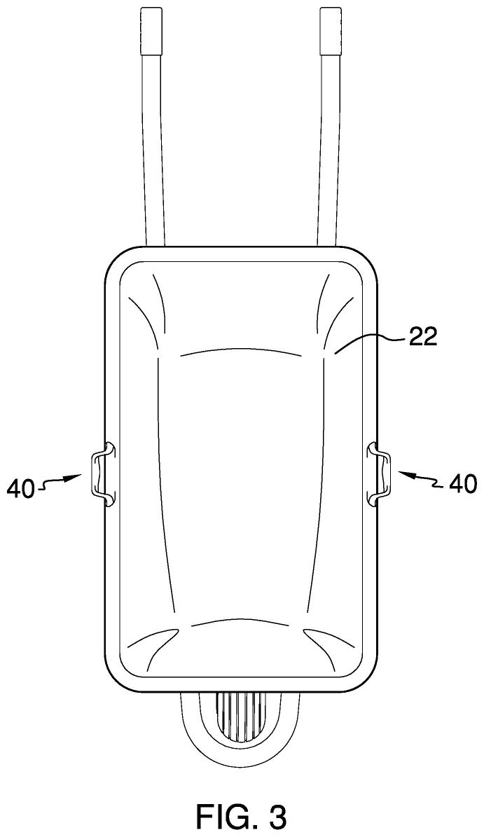

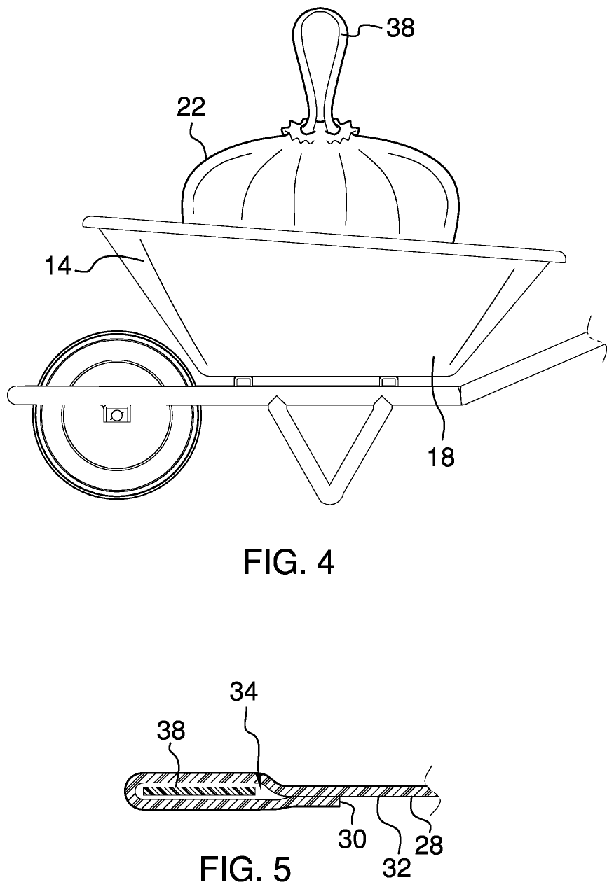

With reference now to the drawings, and in particular to FIGS. 1 through 5 thereof, a new debris bag device embodying the principles and concepts of an embodiment of the disclosure and generally designated by the reference numeral 10 will be described.

As best illustrated in FIGS. 1 through 5, the wheelbarrow debris bag assembly 10 generally comprises a wheelbarrow 12 that has a bucket 14, and the bucket 14 has a lower wall 16 and an outer wall 18 extending upwardly therefrom. The outer wall 18 has a distal edge 20 with respect to the lower wall 16 and the wheelbarrow 12 may be a wheelbarrow 12 of any conventional design. A bag 22 provided and the bag 22 is positionable in the bucket 14 of the wheelbarrow 12 for having debris 24 positioned therein. Moreover, the bag 22 has dimensions corresponding to dimensions of the bucket 14 thereby facilitating the bag 22 to conform to the bucket 14.

The bag 22 has a basal wall 26 and an outside wall 28 extending upwardly therefrom, and the outside wall 28 has a distal edge 30 with respect to the basal wall 26. The basal wall 26 rests on the lower wall 16 of the bucket 14 when the bag 22 is positioned in the bucket 14. The outside wall 28 rests against and is coextensive with the outer wall 18 of the bucket 14 when the bag 22 is positioned in the bucket 14. Alternatively, the bag 22 may be positioned in a collection bin of a riding lawn mower or other similar machine for collecting leaves or grass clippings.

The outside wall 28 of the bag 22 is rolled over onto itself having the distal edge 30 of the outside wall 28 being bonded to an outer surface 32 of the outside wall 28. Thus, a channel 34 is defined that extends around an entire perimeter of the outside wall 28. The outside wall 28 has a pair of openings 36 each extending into the channel 34, and the openings 36 are positioned on opposite sides of the outside wall 28 with respect to each other. The bag 22 is comprised of a deformable material such as plastic or the like and the debris 24 collected in the bag 22 may be leaves, grass clippings or other debris 24 associated with lawn care.

A drawstring 38 is slidably coupled to the bag 22 for selectively closing the bag 22 and the drawstring 38 is positioned within the channel 34. The drawstring 38 extends outwardly through each of the openings 36 in the outside wall 28 of the bag 22 thereby defining a pair of exposed portions 40 of the drawstring 38. The drawstring 38 is tightened around the outer wall 18 of the bucket 14 when the bag 22 is positioned in the bucket 14 for retaining the bag 22 in the bucket 14. Additionally, each of the exposed portions 40 is grasped and urged outwardly from the openings 36 thereby facilitating the bag 22 to be closed for enclosing and thusly transport the debris 24.

In use, the bag 22 is positioned in the bucket 14 of the wheelbarrow 12 such that the bag 22 conforms to the bucket 14. The drawstring 38 is tightened around the outer wall 18 of the bucket 14 for securing the bag 22 in the bucket 14. The debris 24 is dumped into the bucket 14 thereby facilitating the debris 24 to be captured in the bag 22. Each of the exposed portions 40 of the drawstring 38 are urged outwardly from the openings 36 for closing the bag 22 when the bag 22 becomes sufficiently filled with the debris 24. In this way the debris 24 is stored in the bag 22 for subsequent storage and disposal. Thus, the task of collecting leaves or grass clippings while performing yard work is enhanced with respect to bagging and disposing of the leaves and grass clippings.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A wheelbarrow debris bag assembly being configured to be positioned in a wheelbarrow thereby facilitating debris positioned in said wheelbarrow to be subsequently bagged, said assembly comprising:
a wheelbarrow having a bucket, said bucket has a lower wall and an outer wall extending upwardly therefrom, said outer wall having a distal edge with respect to said lower wall, a full length of said distal edge of said outer wall being positioned within a plane;
a bag being positionable in said bucket of said wheelbarrow wherein said bag is configured to have debris positioned therein, said bag having a basal wall and an outside wall extending upwardly therefrom, said outside wall having a distal edge with respect to said basal wall, said basal wall resting on said lower wall of said bucket when said bag is positioned in said bucket, said outside wall resting against and being coextensive with said outer wall of said bucket when said bag is positioned in said bucket wherein said bag has dimensions corresponding to dimensions of said bucket thereby facilitating said bag to conform to said bucket with said distal edge of said outside wall extending along a full length of said distal edge of said outer wall of said bucket; and
a drawstring being slidably coupled to said bag for selectively closing said bag.

2. (canceled)

3. The assembly according to claim 1, wherein said outside wall is rolled over onto itself having said distal edge of said outside wall being bonded to an outer surface of said outside wall to define a channel extending around an entire perimeter of said outside wall.

4. The assembly according to claim 1, wherein said outside wall has a pair of openings each extending into a channel defined on said bag, said openings being positioned on opposite sides of said outside wall with respect to each other.

5. The assembly according to claim 4, wherein:
said drawstring is positioned within said channel, said drawstring extending outwardly through each of said openings in said outside wall of said bag thereby defining a pair of exposed portions of said drawstring;
said drawstring being tightened around said outer wall of such bucket when said bag is positioned in said bucket for retaining said bag in said bucket; and
each of said exposed portions is grasped and urged outwardly from said openings thereby facilitating said bag to be closed wherein said bag is configured to enclose and thusly transport the debris.

6. A wheelbarrow debris bag assembly being configured to be positioned in a wheelbarrow thereby facilitating debris positioned in said wheelbarrow to be subsequently bagged, said assembly comprising:
a wheelbarrow having a bucket, said bucket having a lower wall and an outer wall extending upwardly therefrom, said outer wall having a distal edge with respect to said lower wall, a full length of said distal edge of said outer wall being positioned within a plane;
a bag being positionable in said bucket of said wheelbarrow wherein said bag is configured to have debris positioned therein, said bag having a basal wall and an outside wall extending upwardly therefrom, said outside wall having a distal edge with respect to said basal wall, said basal wall resting on said lower wall of said bucket when said bag is positioned in said bucket, said outside wall resting against and being coextensive with said outer wall of said bucket when said bag is positioned in said bucket wherein said bag has dimensions corresponding to dimensions of said bucket thereby facilitating said bag to conform to said bucket with said distal edge of said outside wall extending along a full length of said distal edge of said outer wall of said bucket, said outside wall being rolled over onto itself having said distal edge of said outside wall being bonded to an outer surface of said outside wall to define a channel extending around an entire perimeter of said outside wall, said outside wall having a pair of openings each extending into said channel, said openings being positioned on opposite sides of said outside wall with respect to each other; and
a drawstring being slidably coupled to said bag for selectively closing said bag, said drawstring being positioned within said channel, said drawstring extending outwardly through each of said openings in said outside wall of said bag thereby defining a pair of exposed portions of said drawstring, said drawstring being tightened around said outer wall of such bucket when said bag is positioned in said bucket for retaining said bag in said bucket, each of said exposed portions being grasped and urged outwardly from said openings thereby facilitating said bag to be closed wherein said bag is configured to enclose and thusly transport the debris.
